(19) United States
(12) Patent Application Publication
(10) Pub. No.: US 2017/0280932 A1
(43) Pub. Date: Oct. 5, 2017

(54) Controlled Bottom Discharge Charcoal Starter

(71) Applicant: Akifumi Yoshida, San Rafael, CA (US)

(72) Inventor: Akifumi Yoshida, San Rafael, CA (US)

(21) Appl. No.: 15/083,415

(22) Filed: Mar. 29, 2016

(51) Int. Cl. A47J 37/07

(52) U.S. Cl. CPC A47J 37/079

(57) ABSTRACT

The controlled bottom charcoal starter is comprised of a fire starting cylindrical tube, a set of two separate but mirror imaged half grates pivotal along the line of the diametrical center of the starter cylinder, a lock and release mechanism, a handle grip and a button cap. The two half grates, which are formed by a one continuous steel rod, are locked horizontally in the same plane to form shelves for loading un-ignited charcoal in the starter cylinder tube. Once the charcoal is ignited, the lock mechanism releases the grates to pivotally rotate downward inside the charcoal starter cylinder so as to lower the hot charcoal briquettes onto a barbeque grill at a controlled rate of discharge. This controlled bottom discharge charcoal starter minimizes hot ash flying outside of the cylinder and makes it safer to use.

### BACKGROUND OF THE INVENTION

Dispensing hot ignited charcoal from commercially available cylindrical tube charcoal starters is dangerous and possibilities of burn injuries exist. Typically a user needs to turn the charcoal starter cylinder upside down or tilt to a greater downward angle to discharge the hot ignited charcoal out of the charcoal starter cylinder. This operation results in rolling ignited charcoal briquettes and hot ash flying uncontrollably on the grate in a barbeque grill. Once charcoal briquettes are discharged from a charcoal starter, a spatula or other tools is employed to spread the charcoals evenly on the grill. In addition, the perforated metal sheet grate provided in the currently available charcoal starters rusts easily and disintegrate after a few seasons in the hot environment and the outdoor elements.

There is a need to controllably discharge the hot ignited charcoals from a charcoal starter in order to minimize flying hot ash and also eliminate the need for an extra tool to spread the charcoal on the barbeque grill, thus making the charcoal starting operation safer for a user. Furthermore, there is a need for an improved charcoal starter with a simple design, a low manufacturing cost, yet having a longer service life.

### TECHNICAL FIELD

This invention relates to the charcoal starter with a bottom discharge. The present invention relates particularly to a controlled bottom discharge charcoal starter with a simple and low cost, yet an innovative grate design and construction and an innovative grate lock and release mechanism.

### DESCRIPTION OF PRIOR ARTS

U.S. patent application 0040886 by Phelps, et al employs a single piece perforated circular metal sheet grate pivoting at an off-diametrical center of a charcoal starter cylinder and a grate release mechanism. The charcoal briquettes, when discharged, are prone to hang up inside the cylinder as the grate cannot fully open unless the grate width is narrower than the length of pivoting line inside of the cylinder as is the case for Byars's design below. The handle for the grate release mechanism, however insulated, is positioned too close to the hot heat shield and a potential for burn injury exists on fingers, if a user comes to contact with it accidentally. This art also employs a spring in the grate release mechanism which is prone to a failure in a short time frame in this extremely hot application environment or outdoor elements. Furthermore, the discharging of hot charcoal is uncontrolled as the grate rotates down freely once the release mechanism is activated.

U.S. Pat. No. 5,638,807 granted to Flamenbaum employs two half perforated metal sheet grates, a compression spring, grate support pegs, wires, etc. This art, once the release mechanism is activated, depends on the weight of charcoal to pivot the two half grates at the diametrical center of the cylinder. However, the grates open downward at a limited angle due to the spring mechanism in the center of the cylinder. In this design, the charcoal briquettes are prone to jam up inside the cylinder as the charcoal does not have clear full passage inside the cylinder. Again, a spring is used which Is prone to fail in the hot environment. In addition, the charcoal is dropped with no control.

U.S. Pat. No. 4,531,507 to Gerson has a center pivoting circular grate. This art needs to raise a half of charcoal briquettes on the grate so that the other half is able to rotate down in order to discharge from the cylinder. However, the weight and friction of charcoal briq\dot{u}ettes moving against each other in the cylinder can be too great to raise or, if forced, the grate metal sheet is prone to bend.

U.S. Pat. No. 3,884,214 to Duncan uses a sliding grate that slides out of the path of the charcoal. However, the charcoal is prone to wedge in the cylinder opening and sliding out the grate screen is prone to become difficult or, if forced, break up the charcoal briquettes. Furthermore, this art again allows the charcoal to discharge uncontrollably from the cylinder.

U.S. Pat. No. 3,167,040 to Byars uses a slightly corn shaped cylinder and a circular perforated metal sheet grate which has the grate pivoting line off center close to the cylinder wall. The idea is that as the cylinder is lifted, the grate rotates down. However, because the grate is the widest in the diametrical center, the grate does not rotate beyond the point at which the width of the grate is the same as the width of the cylinder opening. This results in jammed charcoal inside the cylinder.

To summarize, the bottom discharge charcoal starters heretofore known suffer from one or more of following disadvantages:
a. They are complicated in design and employ too many parts. Therefore, they are more expensive to make, or are not robust and they are prone to fail in a short time in the extremely hot environment and the outdoor elements.
b. Springs are prone to fail in a short time in the charcoal starter application.
c. A currently available perforated metal grate rusts easily and lasts only a few seasons. Also, they have more metal covered area than grates made of one continuous steel rod. The steel rod grates in this invention have more open areas than the grate made of a perforated sheet metal. This enables to expose the charcoal briquettes to more open flames from the fire starting paper which results in faster ignition of charcoal.
c. Some bottom discharge charcoal starter designs may not be practical or workable in the actual field application as charcoal briquettes are prone to jam inside the cylinder as they try to slide out when the path is not fully open.
d. The user's hand is exposed or comes very close to contact a hot metal surface or parts.

### SMMARY OF THE INVENTION

In view of the forgoing disadvantages inherent in the known types of bottom discharge charcoal starter, the present invention provides a new innovative controlled bottom discharge charcoal starter, wherein the same can be utilized for effectively dispensing the ignited hot charcoal from the bottom of the charcoal starter. As such, the general purpose of the present invention, which will be described subsequently in greater detail, is to provide a new improved charcoal starter which has many of the advantages of the charcoal starters discussed. It also has many novel features that result in a charcoal starter which is not anticipated, rendered obvious, suggested, or even implied by any of the prior art charcoal starter, either alone or any combination thereof.

The charcoal starter of this invention is comprised essentially of a cylindrical metal tube with multiple holes in the lower section below the grate for fire starting air intake purposes, a set of two separated but mirror imaged shape grates, a grate lock and release mechanism, a heat shield, and a handle. The lower section below grates is used to house crumpled paper for starting a fire. Above It, there are two charcoal grates to support charcoals to be ignited. The charcoal is loaded to fill the rest of the upper cylinder aperture. Outside of the cylinder there are two sets of grate rod ends penetrating through the cylinder walls, a grate lock and release mechanism, a heat shield, handle support metal bars, and a handle.

The uniqueness of this charcoal starter is the simple design and construction of the grates and grate lock and release mechanism.

There is a set of two separate but mirror imaged half grates. Each of said grates is formed by one continuous metal rod. Said grates are placed inside the cylinder through two separate but closely located pivotal holes adjacent to each other in the handle side while the other ends in a diametrically opposite wall of the cylinder at the same height. However, on the handle side, the grate rod ends are extended and formed at a right angle perpendicular to the grate planes. These ends are contained loosely in the lock and release mechanism housing.

The lock and release mechanism is comprised of a housing which is made of a U-shaped metal sheet. It has an open center that is slightly wider than the two grate ends side by side separated in the center. The two grate rod ends are fitted loosely in each pocket of the housing opposite from each other.

The housing of the lock and release mechanism is attached at the vertical center to the shorter vertical end of a J-shaped rod. The rod penetrates through a hole in the flat lower handle support metal bar. Then it forms a right angle and follows the underside of the lower handle support metal bar to the handle. The lower handle support metal bar, has a lock to hold the rod from sliding down. The longer side of the J-shaped rod penetrates a hole through the handle and ends with a button cap above the handle.

The button cap is pulled up which moves up the connected lock and release mechanism housing. This operation holds the rod ends in a substantially vertical position. In turn, the two halves of the grates form substantially horizontal to make shelves for loading charcoal into the cylinder.

After the charcoal is ignited and hot, the button cap is pushed down which moves down the connected lock and release mechanism housing and the connecting rod moves out of the lock. This operation rotates both of the half grates downward pivoting adjacent to each other at the diametrical cylinder center as visualized in the closed wing of an upside down butterfly. Then the charcoal slides down internally to the lower section of the cylinder. The rate of the drop is controlled by the speed of lowering the button cap. This controls the amount of hot ash spewing out from the cylinder top opening.

The user holds the handle and moves the cylinder of the charcoal starter while lifting slightly and discharging more hot charcoal briquettes as desired. This eliminates a need for an extra tool to spread the charcoal on a barbeque grill.

Once the lock and release mechanism releases the grates, the grate halves swing freely preventing any jamming of charcoal in the cylinder while the charcoal is discharged. The cylinder bottom is used to spread charcoal briquettes onto the barbeque grill grate. This enables the ignited briquettes to be placed where the user needs them without using other tools.

It is understood that that this invention is not limited in its application to the details and to the arrangements of the components set forth in the following description or illustrated in the drawings. This invention is capable of other alternate embodiments. Also, it is understood that the phrases and terminology employed herein are for the purpose of description and should not be regarded as limiting.

As such, those skilled in the art may readily utilize this invention for designing of other structures, methods and systems for carrying out the purpose of the present invention. Therefore, it is important that the claims will be regarded as including such equivalent constructions insofar as they do not depart from the spirit and scope of the present invention.

### LIST OF REFERENCE NUMERALS IN THE DRAWINGS

1—Charcoal starter cylinder

2—Fire starting air vent hole (typ.)

3—Charcoal starter handle upper support bar

4—Charcoal starter handle lower support bar

5—Charcoal starter handle

6—Heat shield

7—A half grate

7′—A mirror imaged half grate

8—Grate pivot hole (typ.)

9—Lock and release mechanism housing

10—Lock and release mechanism connecting rod

11—Lock and release mechanism rod hole on lower handle support bar

12—Lock and release mechanism rod hole in the handle

13—Lock and release mechanism button cap

14—Lock and release mechanism lock

### BRIEF DESCRIPTION OF THE DRAWINGS

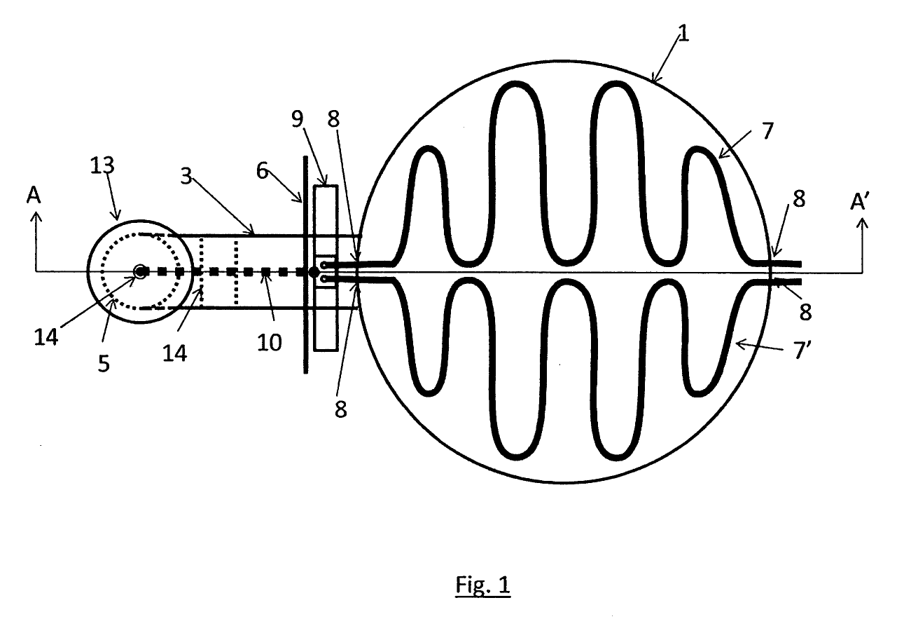

FIG. 1 shows a top view of this invention.

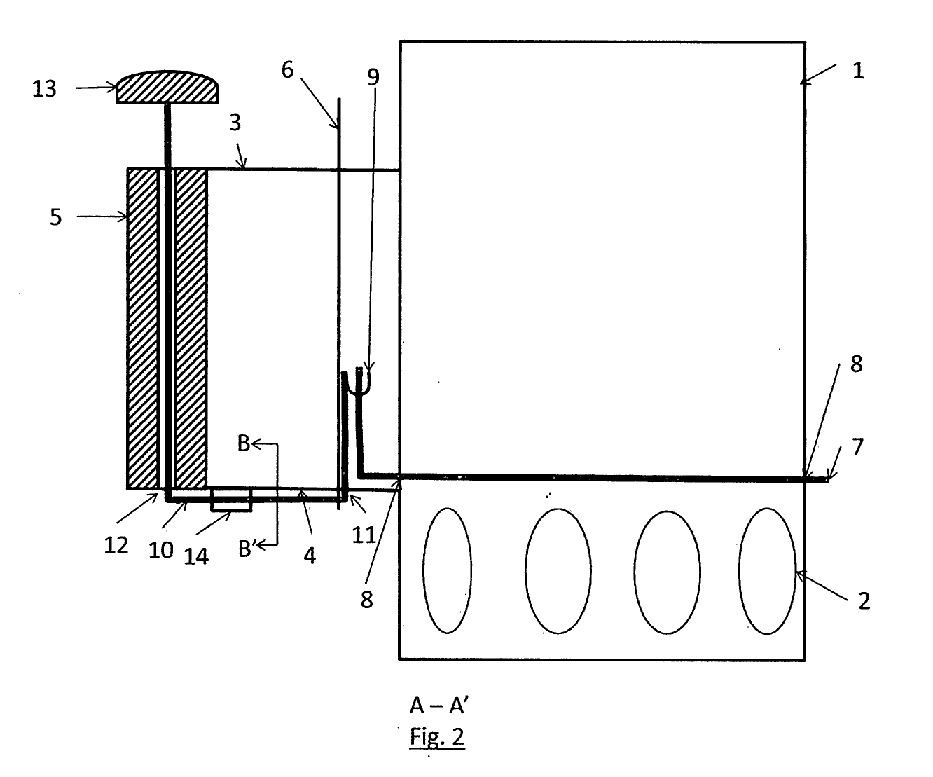

FIG. 2 shows a side view and the cross section A-A′ in FIG. 1.

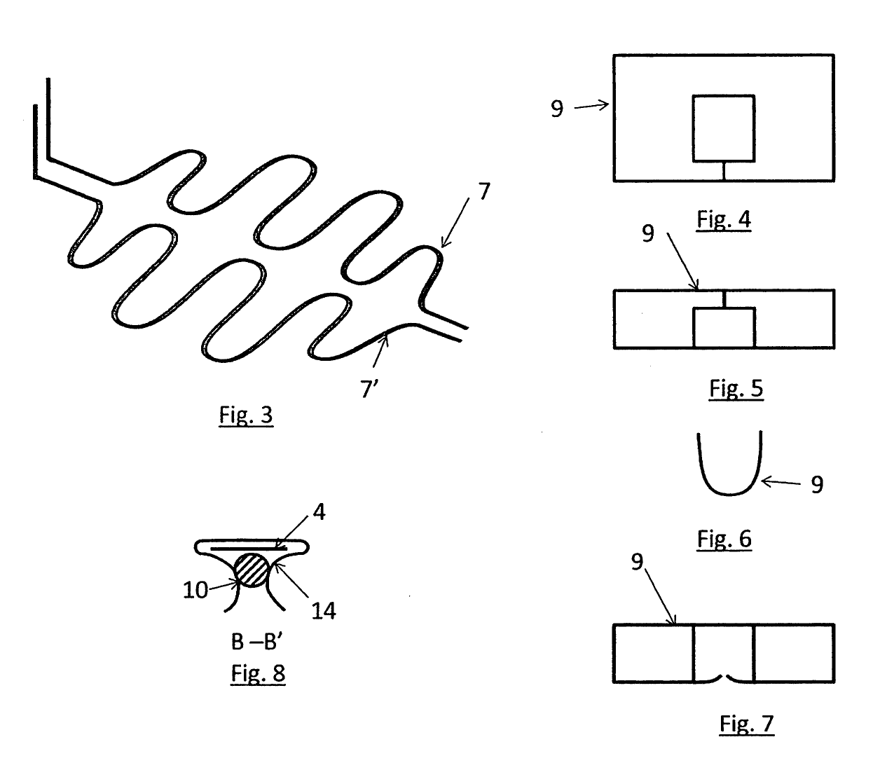

FIG. 3 shows an isometric view of the mirrored half grates 7 & 7′.

FIG. 4 shows the unformed lock and release mechanism housing 9.

FIG. 5 shows a front view of the lock and release mechanism housing 9.

FIG. 6 shows a side view of the lock and release mechanism housing 9.

FIG. 7 shows a top view of the lock and release mechanism housing 9.

FIG. 8 shows a front view of the lock and release mechanism lock 14.

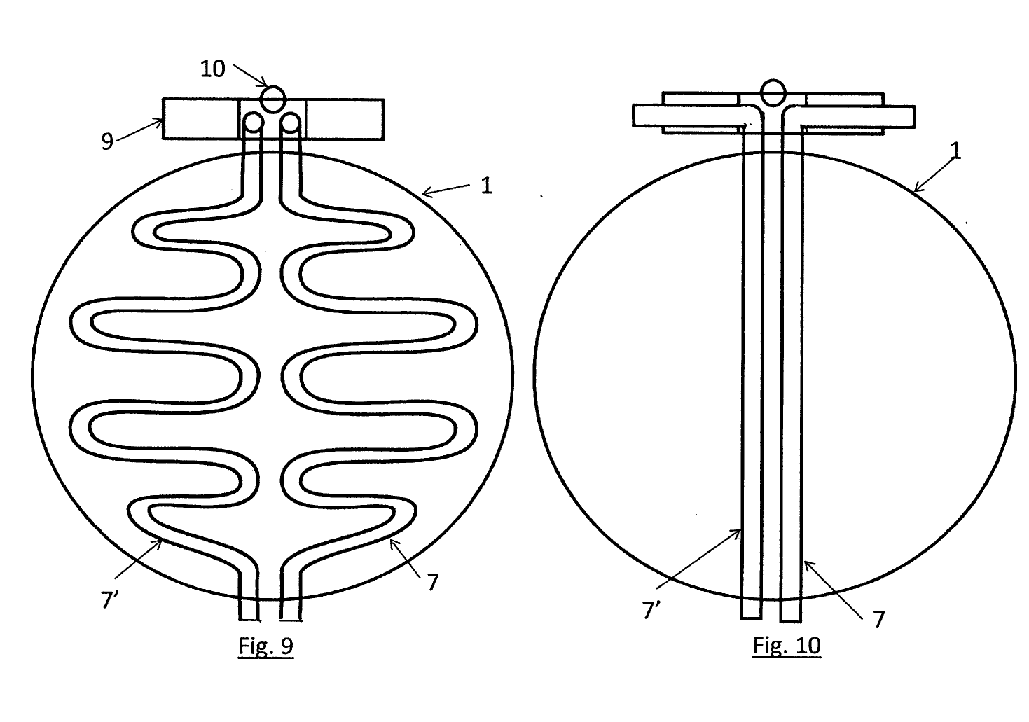

FIG. 9 shows a top view of two mirror imaged grates 7 & 7′ and the lock and release mechanism housing 9 when the grates are locked horizontal.

FIG. 10 shows a top view when the grates 7 & 7′ are rotated downward.

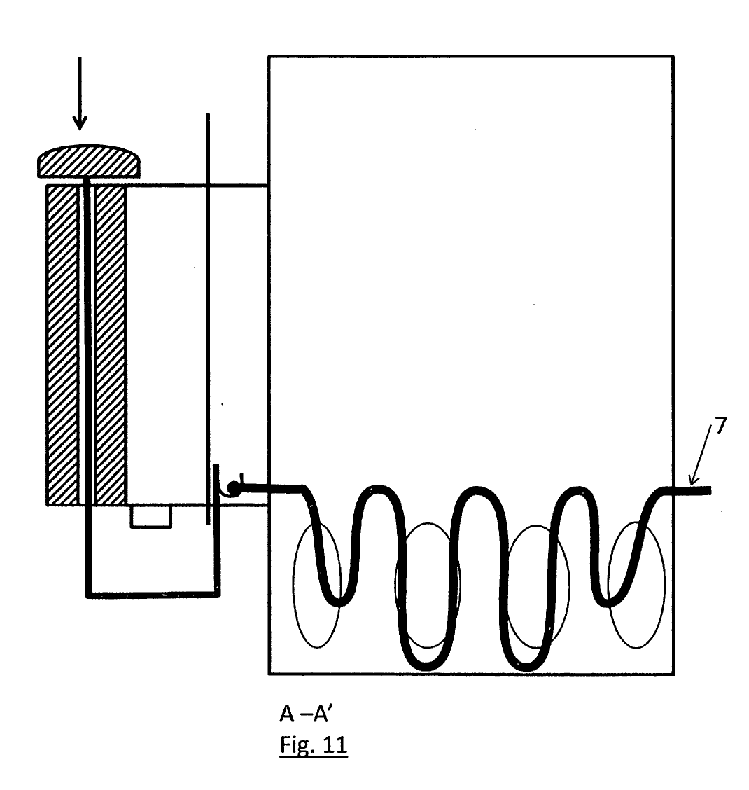

FIG. 11 is added to show when the button cap 13 is pushed down.

### DETAILED DESCRIPTION OF THE PREFERED EMBODIMENT

Referring to FIG. 1 which shows the top view of this invention of a controlled bottom discharge charcoal starter. This view shows the two grate halves 7 & 7′ are locked horizontal ready to accept the charcoal. For more detail, refer to FIG. 2 for the side view.

Referring to FIG. 2 which shows the cross section A-A′ in FIG. 1. In this preferred embodiment of the charcoal starter 1, one end of a half grate 7 penetrates through the charcoal starter wall and the other end penetrates the same in the diametrically opposite handle attachment side through holes 8 that act as pivotal points of the grate 7. The lock and release mechanism housing 9 is located between the cylinder 1 and the heat shield 6. The housing 9 is connected to a J-shaped rod 10 penetrating through the hole 11 in the lower handle support bar 4. The rod 10 runs horizontally and is captured by the lock 14. The lock and release rod 10 then turns vertically up, through the hole 12 inside the handle 5, and terminates with a button cap 13.

FIG. 3 shows clearly the mirror imaged half grates 7 & 7′ in a horizontal position and the grate ends turned perpendicular to the grate plane. FIG. 3 also shows the grate halves 7 & 7′ are formed by a continuous metal rod.

FIGS. 4, 5, 6 and 7 show the housing 9 in various views. FIG. 4 is a flat sheet metal before forming the housing 9. FIG. 5 shows a front view after forming in U-shape. FIG. 6 shows a side view. FIG. 7 shows a top view. The housing 9 is made of a sheet metal folded in U-shape. The center bottom and a part of the side wall of the “U” is cut open wide enough to hold the two half grate ends side by side. Each of the grate ends is held in its own side of the center opening.

FIG. 8 shows a cross section B-B′ in FIG. 1 for the lock and release mechanism lock 14 mounted on the lower handle support bar 4. The rod 10 is held inside cavity of the lock 14 to prevent the housing 9 from sliding down. When the button cap 13 is pushed down, the rod 10 is pushed out of the lock 14..

FIG. 9 shows a top view of the grates 7 & 7′ and grate ends in a locked upright position in the housing 9.

FIG. 10 shows a top view of the lock and release mechanism in a pushed down position. The grate halve 7 & 7′ are rotated down making a clear path for the charcoal to move down onto the grate of a barbeque grill.

FIG. 11 is looking at the cross section of A-A′ in FIG. 1 to show the FIG. 10 in detail. When the button cap 13 is pushed down, the rod 10 is pushed out of the lock 14 and the connected housing 9 moves down. The grate ends rotate away from each other until each end rests horizontally in the housing 9 pockets as shown in FIG. 10. In turn, it causes the grate halves 7 & 7′ to rotate downward as visualized in an upside butterfly closing its two wings. This movement results in opening the pathway for charcoal to move downward and discharged onto the barbeque grill grate. The rate of discharge is controlled by the speed of pushing down the button cap 13. This slows hot ash flying out of the top of the charcoal starter cylinder 1.

What is claimed is:

1. A bottom discharge charcoal starter comprising of a starter cylinder means, plurality of pivotal half grate means, a grate lock and release means,

2. A bottom discharge charcoal starter in claim 1, wherein the plurality of pivotal half grate means is a set of two equal but mirror imaged shape grates. Each grate half is made of one continuously formed metal rod that the distances relative to the gap between each turn, between the half grates and the inside cylinder wall are narrow enough that typical charcoal briquettes do not fall through. The two half grates fit loosely inside a cylindrical tube means supported by grate pivotal holes adjacent to each other in the handle side and the diametrically opposite wall at the same height of a charcoal starter cylinder. In addition, one end of each half grate is extended and turned at a right angle to the grate plane in mirror image.

3. A charcoal starter in claim 2, wherein the grate lock arid release mechanism means moves the two grate rod ends in the handle side to a substantially vertically upright position, which results in the grate halves to form a substantially horizontal plane at the same height. The lock and release mechanism means also moves both the grate rod ends to the horizontal positions in the opposite pocket of each other in the lock and release housing, thus rotating both half grates to a substantially downward vertical angle so as to create a clear flow path for the hot charcoal briquettes to move down onto the grill and enable a safe release of the hot charcoal.

4. A charcoal starter in claim 3, wherein the downward rotation of the grates is controllable by the speed of lowering the lock and release mechanism by a user.
